(19) United States
(12) Patent Application Publication
(10) Pub. No.: US 2016/0229667 A1
(43) Pub. Date: Aug. 11, 2016

(54) METHOD AND DEVICE FOR CHECKING THE INTEGRITY OF LOAD BEARING MEMBERS OF AN ELEVATOR SYSTEM

(71) Applicants: Igino CEREGHETTI, Sion (CH); Simone PELLASCIO, Losone (CH)

(72) Inventors: Igino CEREGHETTI, Sion (CH); Simone PELLASCIO, Losone (CH)

(73) Assignee: Kone Corporation, Helsinki (FI)

(21) Appl. No.: 15/099,997

(22) Filed: Apr. 15, 2016

Related U.S. Application Data
(63) Continuation of application No. PCT/EP2013/072078, filed on Oct. 22, 2013.

(51) Int. Cl. B66B 7/12

(52) U.S. Cl. CPC B66B 7/1223

(57) ABSTRACT

A method for checking the integrity of a load bearing member of an elevator comprising tensile elements encapsulated in a case is disclosed; the method comprises the steps of launching a source pulse through tensile elements of said load bearing member and comparing the feedback of said tensile elements with a comparator; tensile elements can be bridged to avoid a blind zone; an elevator system with a checking device to perform said method is also disclosed.

This application is a continuation of PCT International Application No. PCT/EP2013/072078 which has an International filing date of Oct. 22, 2013, the entire contents of which are incorporated herein by reference.

### DESCRIPTION

1. Field of the Invention

The invention relates to a non-visual method for determining the condition of a load bearing member of an elevator. The invention relates in particular to the checking of elevator load bearing members comprising tensile elements encapsulated in a case.

2. Prior Art

A known type of load bearing members for elevators comprises tensile elements encapsulated in a case. Internally reinforced belts are an example of such load bearing members, which provide several advantages over the conventional steel ropes. A traction member for elevators having a number of steel cords encapsulated in a plastic medium is disclosed for example in GB-A-1362514.

The visual inspection of the internal tensile elements is generally not possible and hence the need arises for non-visual inspection. A known method for checking the condition of the tensile elements is the resistance-based inspection, which is based on a measure of the electrical resistance of the tensile elements. A change in the electrical resistance or a deviation from an expected value are interpreted as a damage of the tensile elements.

It has been found, however, that non negligible damages may nevertheless result in small variations of the electrical resistance of common tensile elements such as steel cords. Consequently, the sensitivity of the resistance-based inspection is not satisfactory.

Another drawback is that the absolute measure of the electric resistance of a tensile element is affected by several boundary conditions. Factors that may influence the measure include the temperature, the load and related stress, and also the winding of the load-bearing member around a pulley, which may generate an inductance. A certain deviation from the expected value may arise from said boundary conditions and lead to a false alarm. Taking account of said factors may further reduce the sensitivity of the test.

The purpose of the invention is to eliminate the above drawbacks. In particular, the invention aims to a method for testing electrically conductive tensile elements of a load-bearing member of an elevator, which is safer and more reliable than conventional resistance-based systems.

### SUMMARY OF THE INVENTION

The idea of the invention it to determine the condition of a tensile element by sending a pulse through the tensile element and analysing the feedback pulse which is received from the tensile element. The analysis can be performed with TDR (time domain reflectometer) technique. The feedback of at least two tensile elements is compared according to the method. Since it is assumed that the tensile elements should have the same behaviour, the same feedback is expected; a different feedback from a tensile element can reveal a possible damage.

An aspect of the invention is a method for checking at least one load bearing member of an elevator system according to claim 1. Said load bearing member comprises tensile elements of electrically conductive material encapsulated in a case and the method comprises the steps of:
a) launching a first source pulse through a first tensile element of said load bearing member,
b) launching a second source pulse through a second tensile element of said load bearing member or of another load bearing member of said elevator system,
c) making a comparison between a feedback received from said first tensile element and a feedback received from said second tensile element, and
d) determining a condition of said tensile elements based on said comparison.

The feedback of the tensile elements shall be understood as the detection of a feedback pulse with certain features, or detection of no feedback pulse. In some embodiments (e.g. grounded tensile elements), it is expected that undamaged and uniform tensile elements provide no feedback, and hence a feedback pulse may reveal a damage, for example a non-uniformity of the internal structure which generates a reflection of the source pulse. In some other embodiments (non-grounded), the undamaged and uniform tensile elements are expected to provide a feedback pulse with certain features.

In all the above cases, a deviation between the feedback of two tensile elements can be interpreted as a damage. It is believed that, in most cases, it will be unlikely that two tensile elements are damaged in the same way and at the same time. Factors like aging, stress, temperature, etc. are believed to affect all the tensile elements substantially in the same manner. Hence, when the feedback of a tensile element deviates from the feedback of another element, it is likely that at least one of the two tensile elements is damaged.

Another possibility to inspect the load-bearing member, in accordance with the invention, is to select the tensile elements which are compared each other according to a predetermined pattern. A random pattern can also be used.

It should be noted that this method, due to its comparative nature, is not affected by factors like the winding of the load-bearing member on a pulley, the load distribution, and others. Accordingly, the risk of false alarms is reduced and the method is more reliable.

Preferably, a damage condition of one of said first tensile element and second tensile element is determined when a detected difference of the feedback is greater than a predetermined threshold.

The term of elevator system used in this description and in the claims shall be understood as a system including a single load-bearing member or a plurality of load bearing members. A car is usually suspended to at least two load-bearing members, to comply with the applicable norms, and a plurality of redundant load-bearing members can be used to increase safety. Said elevator system may comprise also comprise more than one elevator and related load-bearing members. According to various embodiments of the invention, a tensile element of a load-bearing member can be checked by making a comparison with one or more tensile elements of the same load-bearing member, or with one or more tensile elements of one or more other load-bearing member(s) of the elevator system. Preferably, the tensile elements of a load-bearing member are compared with the tensile elements of one or more near load-bearing member(s) since it is expected that near load-bearing members are subject to similar working conditions and load and hence they provide a reliable reference.

In some embodiments, the method includes the performing of a cross-check when a possible damage condition is detected. For example, when a difference of feedback between two tensile elements is detected, at least one of said first tensile element and second tensile element can be compared to at least a third tensile element of the load-bearing member. The performing of a cross-check helps to further reduce the risk of a false alarm and may detect which one of the tensile elements is damaged.

More generally, certain preferred embodiments may provide that the tensile elements of a load-bearing member are checked by testing pairs of tensile elements according to steps a) to d) as defined above, and the pairs are selected in such a way that feedback of each tensile element is compared to the feedback of a plurality of other tensile elements of the same or other load-bearing member(s). The pairs of tensile elements which are compared to each other may be selected randomly or in accordance with a predetermined pattern. In one of the various embodiments, the tensile elements are scanned by comparing the feedback of each tensile element to the feedback of each one of the other tensile elements of a load-bearing member. For example if tensile elements are numbered 1, 2, 3, . . . n, the invention provides the comparison 1 vs. 2, 1 vs. 3, . . . 1, vs. n; then 2 vs. 3, 2 vs. 4, . . . and so on.

The comparison of the feedback may include any of: a measure of the time elapsed between the launch of the source pulse and the receipt of a feedback pulse, if any; determination of amplitude of a feedback pulse, determination of the duration of a feedback pulse; analysis of the waveform of a feedback pulse, or a combination thereof.

The elapsed time can be measured very precisely. As mentioned above, a damage will typically originate a reflection of the source pulse and then a feedback pulse. The elapsed time can be used to calculate the location of the damage as a function of the known speed of the pulse in the tensile element. Other features such as the waveform of said feedback pulse may help understanding the nature of the damage, e.g. a short circuit or interruption.

Accordingly, the method is more sensitive and provides more information than resistance-based methods of the prior art, which require determination of an electrical resistance.

Preferably, the first source pulse and the second source pulse are identical and more preferably they are launched simultaneously.

The above method will typically have a so-called blind region, namely a region which is too close to the point of injection of the source pulse for a damage to be detected. Said blind area can be eliminated with the bridged embodiments of the invention.

The bridged embodiments involve that two tensile elements are bridged in pairs, and are tested by alternately launching the source pulse into, and detecting the feedback pulse from, the two tensile elements forming a pair according to the attached claim 6. Hence, a damage near the point of the injection of the first launch and in the blind area will be detected with the second launch.

Another way to eliminate the blind area is to provide a certain dead length of the load-bearing member, which is not stressed during the use, for example being after a fixed point. The length of said dead portion is at least equal to the length of the blind region, in such a way that the useful portion of the load-bearing member is outside the blind region and any damage located therein is detectable.

The following preferred features may apply to the various embodiments of the invention.

A deviation from the expected feedback can be defined with respect to a certain threshold, which sets the tolerance of the system.

The source pulse must have a sufficient energy to travel through the tensile element. Hence, the parameters of the source pulse shall be determined accordingly, taking into account inter alia the length and resistivity of the tensile elements.

Preferably the source pulse has a time duration of around 100 nanoseconds and even more preferably less than 100 nanoseconds. A small duration is preferred to avoid or at least reduce the occurrence of the feedback pulse overlapping the source pulse, which may happen if the damage is too close to the point when the source pulse is injected. Preferably the amplitude of the pulse is less than 50 V, provided it is sufficient to deliver the energy required. A low voltage is preferred to avoid the need of insulation.

A device for carrying out the above method can be integrated in an elevator system. An aspect of the invention is an elevator system according to the attached claims. Said elevator system comprises at least: a car, a load-bearing member including tensile elements made of electrically conductive material and encapsulated in a case, and a checking device for checking the integrity of said load-bearing member according to the method of the invention.

The checking device comprises means to launch a pulse in the tensile elements, such as one or more pulse generators, and a comparator arranged to compare their feedback.

Said checking device may be configured to carry out the test automatically or on manual command. In some embodiments, the checking device performs the test at given intervals of time and/or when certain conditions are met, for example when the elevator car is resting at the lowest floor and hence the load-bearing member is fully deployed, which is the preferred condition for testing the load-bearing member.

In a manual embodiment, the elevator system preferably comprises a suitable interface accessible to the qualified personnel only. For example a control panel of the elevator may include a test button to perform the inventive method and receive a signal such as “green light” or “alarm”. Accordingly, the integrity of the load-bearing member can be checked manually when it is appropriate, e.g. during the routine maintenance of the elevator system.

In other embodiments, the test can be performed with suitable external equipment including the means to generate the pulse and receive and compare the feedback. Said means shall be electrically connected to suitable interface means of the tensile elements of the load-bearing member.

In the preferred application of the invention, the elevator is a counterweight-less elevator and the load-bearing member has the form of a belt. The term belt is used to denote a load-bearing member which typically has a width substantially larger (e.g. several times larger) than thickness. According to various embodiments, said belt can be a toothed belt or a flat belt. The tensile elements can be metal cords, such as steel cords, made of several strands. The load-bearing member may also include non-metal tensile elements. For example the invention can be applied to a load-bearing member as disclosed in WO-A-2009 090299.

The case where tensile elements are encapsulated is of a higher resistivity than the tensile elements. For example the tensile elements are steel cords or stainless steel cords and the case is made of a plastic material such as polyurethane (PU).

The invention also relates to an elevator system according to the attached claims.

The advantages of the invention will be now elucidated with reference to the attached figures.

### DESCRIPTION OF FIGURES

FIG. 1 is a scheme of a first way of carrying out the inventive method, according to a first embodiment.

FIG. 2 is a scheme of another way of carrying out the inventive method, according to a second embodiment with bridged tensile elements.

FIG. 3 shows an example of pulse and feedback which denote a damage in a tensile element, according to the invention.

### DETAILED DESCRIPTION OF PREFERRED EMBODIMENTS

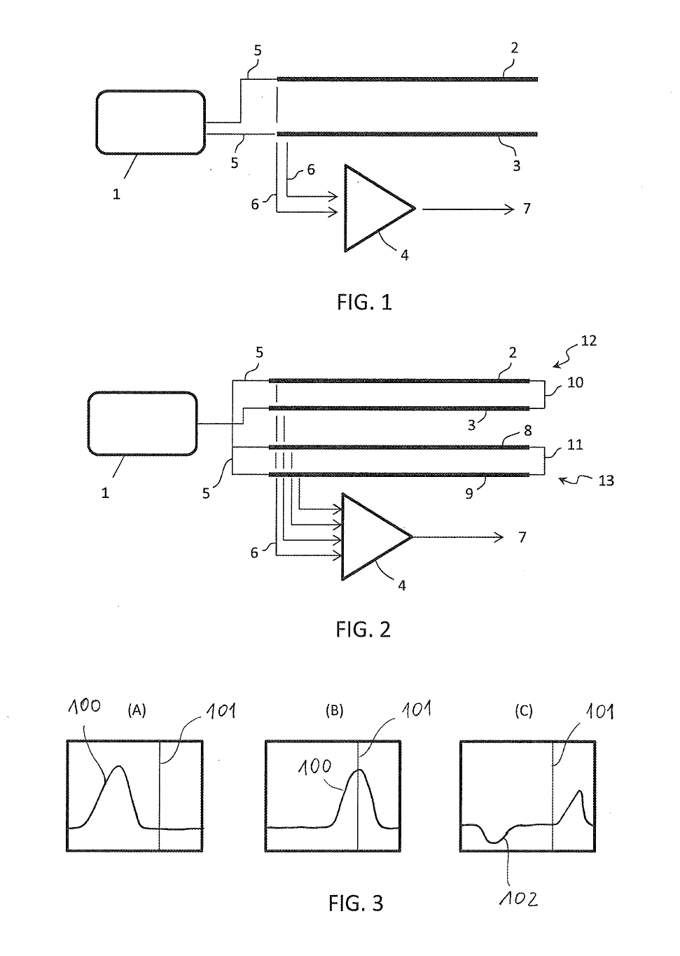

Referring to FIG. 1, the block 1 denotes a pulse generation unit, which may include one or more pulse generators, connected to tensile elements of a load-bearing member of an elevator. Said tensile elements are for example steel cords 2, 3. A comparator 4 is also electrically connected to said steel cords 2, 3.

The unit 1 can launch a pulse through the steel cords 2, 3 while their feedback can be compared by means of the comparator 4.

The method comprises preferably the following steps. A pulse generated by the unit 1 and having a known amplitude and duration, for example 50 V and 100 ns, is launched through steel cords 2, 3 via the input connections 5.

In each cord 2 or 3, the pulse will normally travel the whole length of the cord. Depending on the cords being grounded or not, the cords 2, 3 are expected to give a certain feedback pulse or no feedback. However, a damage of the cord will result in a different feedback pulse, as elucidated for example in FIG. 3.

Any feedback reaches the comparator 4 via connections 6. The output 7 of the comparator 4 is normally expected to be null or close to null; a non-null output 7, possibly over a certain threshold, may be interpreted as a damage of one of the cords 2, 3.

FIG. 2 relates to a bridged embodiment of the invention.

The steel cords 2, 3 and 8, 9 are bridged by means of bridge connections 10, 11 to form two pairs 12, 13.

The method involves basically two steps. A source pulse is launched into one steel cord of each pair 12 and 13, for example cords 2 and 8, and the feedback pulse (received via connections 6) is checked by the comparator 4. Then, a source pulse is launched into the other steel cord of each pair, in the example the cords 3 and 9, and again the feedback pulses are analysed. This method avoids the blind zone since for example a damage undetected in the first step, being too close to the connection to pulse generator 1, will be revealed in the second step, or vice-versa.

FIG. 3 shows the principle underlying the invention. A source pulse 100 having a known amplitude and duration is launched through a conductive tensile element, for example a steel cord (FIG. 3, A). Line 101 denotes the position of a damage of the cord, for example a location where the cord is worn and/or the cross section is reduced due to failure of some of the wires which compose the cord. The damage 101 will normally reflect at least partly the source pulse 100 (FIG. 3, B), thus generating an unexpected feedback 102 (FIG. 3, C) which can be interpreted as a symptom of a damage. Furthermore, knowing the speed of the source pulse and the length of the tensile cords, the system may calculate and show the location of the damage 101 along the cord.

The invention is applicable to various load-bearing members of elevators. For example the load-bearing member may be a belt with steel cords in a polyurethane body, and each cord is composed of several steel tangled wires. The invention however may be applied to other embodiments including load-bearing members with non-metallic tensile elements.

1. A method for checking at least one load bearing member of an elevator system, said load bearing member comprising tensile elements of electrically conductive material encapsulated in a case, the method comprising the steps of:
a) launching a first source pulse through a first tensile element of said load bearing member,
b) launching a second source pulse through a second tensile element of said load bearing member or of another load bearing member of said elevator system,
c) making a comparison between a feedback received from said first tensile element and a feedback received from said second tensile element, and
d) determining a condition of said tensile elements based on said comparison.

2. A method according to claim 1, including the step of determining a damage condition of one of said first tensile element and second tensile element when said comparison reveals a difference between the feedback of the tensile elements greater than a predetermined threshold.

3. A method according to claim 2, comprising the step of: when a damage condition is determined, at least one of said first tensile element and second tensile element is compared at least to a third tensile element of said load-bearing member or of another load-bearing member of the elevator system, according to steps a) to d).

4. A method according to claim 1, wherein: the tensile elements of a load-bearing member are tested by testing pairs of tensile elements according to steps a) to d), and wherein the pairs are selected in such a way that each tensile element of said load bearing member are compared to a plurality of other tensile elements of the same or other load bearing member(s) according to a predetermined pattern or according to a random pattern.

5. A method according to claim 1, wherein the step c) includes any of: a measure of the time elapsed between the launch of the source pulse and the receipt of any feedback pulse; determination of amplitude of any feedback pulse, determination of the duration of any feedback pulse;
analysis of the waveform of any feedback pulse, or a combination thereof.

6. A method according to claim 1, wherein tensile elements of said load-bearing member are bridged in pairs, the method including the steps of:
launching a first source pulse into a first tensile element of a first bridged pair and launching a second source pulse into a first tensile element of a second bridged pair, and making a comparison of the received feedback,
and
repeating the test by launching a first source pulse into the second tensile element of said first bridged pair and launching a second source pulse into the second tensile element of said second bridged pair, and making a comparison of the received feedback.

7. A method according to claim 1, the first source pulse and the second source pulse being identical.

8. A method according to claim 1, wherein the first source pulse and the second source pulse are launched simultaneously.

9. A method according to claim 1, wherein said source pulse has a time duration of 100 nanoseconds or less.

10. A method according to claim 1, wherein said source pulse has an amplitude not greater than 50 V.

11. An elevator system including at least one car and at least one load-bearing member, the load bearing member including tensile elements made of electrically conductive material and encapsulated in a case, the elevator comprising a checking device for checking the integrity of said load-bearing member according to the method of claim 1, said device comprising at least: a pulse generator connected to tensile elements of said load-bearing member and possibly to tensile elements of other load-bearing members of said elevator system, and a comparator which is also connected to said tensile elements and is arranged to compare the feedback of tensile elements, and to analyse said feedback in order to determine a condition of said tensile elements.

12. An elevator system according to claim 11, said checking device being configured to perform a test of the integrity of the tensile elements at predetermined intervals of time.

13. An elevator system according claim 11, said control system being configured to perform a test of the integrity of the tensile elements when a call of the elevator is made while the car is positioned at the lowest floor.

14. An elevator system according to claim 11, said load-bearing member being formed as a belt and the elevator having no counterweight.

15. An elevator system including at least one car and at least one load-bearing member, the load bearing member including tensile elements made of electrically conductive material and encapsulated in a case made of electrically resistive material, the elevator comprising a checking device for checking the integrity of said load-bearing member, said device comprising at least: a pulse generator connected to tensile elements of said load-bearing member and a comparator or analyzer which is also connected to said tensile elements and is arranged to compare or analyze the feedback of tensile elements, and criteria for determine whether the condition of said tensile element is acceptable or not.
